(19) United States
(12) Patent Application Publication
(10) Pub. No.: US 2014/0241585 A1
(43) Pub. Date: Aug. 28, 2014

(54) SYSTEMS, METHODS, AND APPARATUS FOR OBTAINING INFORMATION FROM AN OBJECT ATTACHED TO A VEHICLE

(71) Applicants: Alexandra Zafiroglu, Portland, OR (US); David Graumann, Portland, OR (US)

(72) Inventors: Alexandra Zafiroglu, Portland, OR (US); David Graumann, Portland, OR (US)

(21) Appl. No.: 13/977,602

(22) PCT Filed: Dec. 29, 2011
(86) PCT No.: PCT/US11/67841

§ 371 Date: May 2, 2014

(51) Int. Cl. G06K 9/00; G06K 7/10

(52) U.S. Cl. CPC G06K 9/00791; G06K 7/10366
USPC 382/104

(57) ABSTRACT

Certain embodiments of the invention may include systems, methods, and apparatus for obtaining information from objects attached to a vehicle. According to an example embodiment of the invention, a method is provided for receiving one or more camera images from a front-facing camera attached to a vehicle; locating, from the one or more camera images, one or more region of interest (ROI) images; processing the one or more ROI images; outputting the one or more processed ROI images to a display within the vehicle; receiving radio frequency identification (RFID) information from a RFID reader attached to a front portion of the vehicle; and outputting one or more commands based at least in part on one or more of the RFID information or the processing of the one or more ROI images.

### FIELD OF THE INVENTION

This invention generally relates to obtaining information from vehicles, and in particular, to receiving electronic information and image information associated with an object attached to a vehicle.

### BACKGROUND OF THE INVENTION

Vehicle bumpers have been utilized for several decades as a means for conveying information to nearby observers. The first production vehicle bumper was introduced in 1927, and by World War II, it was commonplace to see messages attached to vehicle bumpers. Commercial advertisements, humorous sayings, political messages, affiliations, etc., can be printed on adhesive-backed PVC bumper stickers and applied to nearly any surface of a vehicle. License plate frames and vanity plates are other common ways to convey information on a vehicle. For example, car dealers usually install license plate frames on their new and used vehicles to advertise their business.

Many bumper stickers utilize symbols, images, and/or a few words in an attempt to represent complex ideas. An observer usually needs to be within close proximity of another vehicle to read and understand such information. However, even when an observer is positioned directly behind a vehicle, the message may not be fully comprehended by an observer, and the opportunity to convey information to that observer may be lost.

### BRIEF DESCRIPTION OF THE FIGURES

Reference will now be made to the accompanying figures and flow diagrams, which are not necessarily drawn to scale, and wherein:

FIG. 1 is a diagram of an illustrative vehicular information reading arrangement, according to an example embodiment of the invention.

FIG. 2 is an illustrative example of information objects that may be attached to a vehicle, according to embodiments of the invention.

FIG. 3 is a block diagram depicting information capturing and processing elements, according to an example embodiment of the invention.

FIG. 4 is a diagram of an illustrative portable reader, according to an example embodiment of the invention.

FIG. 5 is a block diagram of an illustrative system, according to an example embodiment of the invention.

FIG. 6 is a flow diagram of an example method according to an example embodiment of the invention.

### DETAILED DESCRIPTION

Embodiments of the invention will be described more fully hereinafter with reference to the accompanying drawings, in which embodiments of the invention are shown. This invention may, however, be embodied in many different forms and should not be construed as limited to the embodiments set forth herein: rather, these embodiments are provided so that this disclosure will be thorough and complete, and will fully convey the scope of the invention to those skilled in the art.

In the following description, numerous specific details are set forth. However, it is understood that embodiments of the invention may be practiced without these specific details. In other instances, well-known methods, structures, and techniques have not been shown in detail in order not to obscure an understanding of this description. References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description, the term information object may refer to a bumper sticker, a license plate tag, a vanity license plate, a radio frequency identification (RFID) element, a logo, an image, text, or any other form that may be attached, embedded, or projected on a vehicle for conveying information.

Certain example embodiments may read and/or capture information from an information object attached to a vehicle. For example, the information object may be a bumper sticker displaying a symbol. In this example, a camera and processor may be utilized to capture an image of the symbol, process the image, and query a local or remote database for additional information related to the symbol. In one example embodiment, a camera and processor may be attached to a first vehicle, and one or more information objects may be attached to a second vehicle. According to an example embodiment, the camera/processor may be in the form of a portable device and not necessarily attached to the first vehicle.

According to an example embodiment, the camera may be configured to track the information object (via dynamic focus, etc.,) to obtain a clear image of the visual information printed on the object, for example. In an example embodiment, this image information may be displayed for viewing. In this sense, the camera/processor/display may provide enhanced visibility of the information associated with the information object.

According to another example embodiment, a radio frequency identification (RFID) chip or tag may be embedded in the information object, and a RFID reader may be utilized to read electronic information stored on the RFID tag. In one example embodiment, the RFID tag may be configured, when read, to transmit a pointer address (such as a web address) to the reader. In another example embodiment, the RFID tag memory may be configured or programmed with computer-readable code (ASCII for example) so that a short message may be transmitted via the RFID reader for display.

According to other example embodiments, a combination of image information and electronic information may be stored and/or associated with the information object, and may be respectively captured with a camera and a reader. This information may include a web address, additional text, images, etc., to enhance the somewhat limited information that is directly observable from the image or visual text information alone.

Various components and arrangements may be utilized for presenting, reading, and displaying information associated with a vehicle, according to example embodiments of the invention, and will now be described with reference to the accompanying figures.

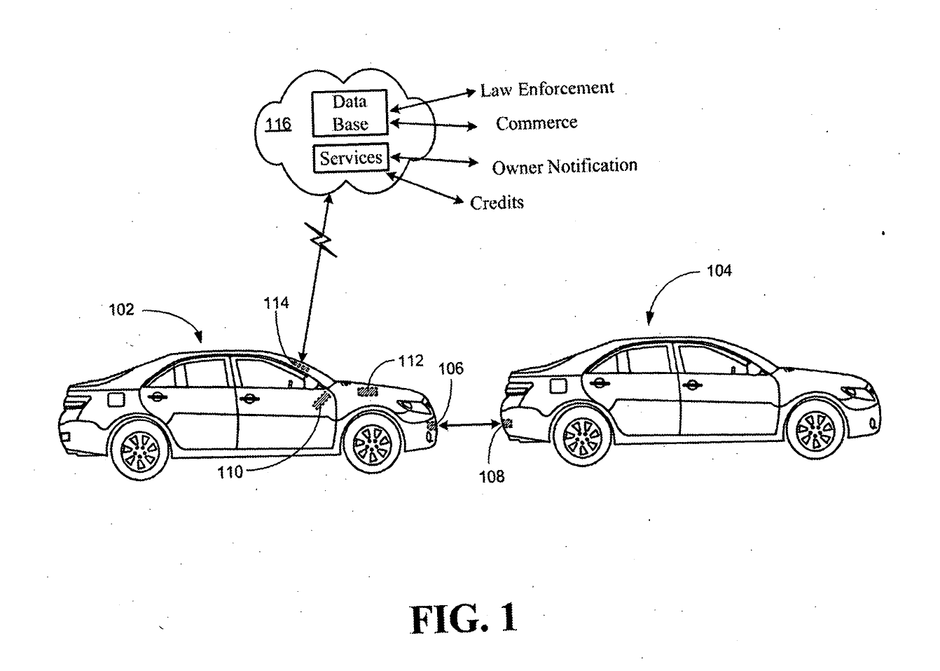

FIG. 1 illustrates an example vehicle information reading arrangement including a first vehicle 102 and a second vehicle 104. According to an example embodiment, the first vehicle 102 includes one or more information readers 106 for reading one or more information objects 108 attached to the second vehicle. In an example embodiment, the one or more information objects can include a bumper sticker, a license plate tag, a vanity license plate, a radio frequency identification (RFID) element, a logo, an image, a decal, text, or any other form that may be attached, embedded, or projected on the second vehicle 104 for conveying information.

In an example embodiment, the one or more information readers 106 may include a camera. According to an example embodiment, the one or more information readers 106 may include a RFID reader. In accordance with an example embodiment, the camera may receive one or more camera images, for example, from a front-facing camera attached to the first vehicle 102. For example, the front-facing camera may be attached to the front bumper of the first vehicle 102, or it may be attached inside the cabin area of the first vehicle 102. In accordance with an example embodiment, one or more region of interest (ROI) images may be located from the one or more camera images and may be processed and output to a display 110 within the first vehicle 102 for viewing by the occupants of the first vehicle 102. In accordance with an example embodiment, processing of one or more ROI images includes one or more of determining camera focus, adjusting camera focus, determining image stability, enhancing image stability, performing optical character recognition, determining a shape, performing shape, recognition, determining one or more colors, adjusting sharpness, adjusting contrast, or adjusting brightness.

In accordance with an example embodiment, the RFID reader may receive RFID information from a RFID tag attached to the second vehicle 104. In one example embodiment, the RFID tag attached to the second vehicle 104 may be configured, when read, to transmit a pointer address (such as a web address) to the RFID reader. In another example embodiment, the RFID tag memory may be configured or programmed with computer-readable code (ASCII for example) so that a short message may be transmitted via the RFID reader and visualized on the display 110 in the first vehicle 102.

According to other example embodiments, a combination of image information and electronic information may be stored and/or associated with the information object 108, and may be respectively captured by the information reader 106, for example, the camera and the RFID reader. This information may include a web address, additional text, images, etc., to enhance the information that is directly observable from the image or visual text information alone that may be printed on the information object 108.

According to an example embodiment, the first vehicle 102 may include a navigation system 112 that may receive global positioning system (GPS) information for automatically associating, for example, the location at which the information object 108 was read by the information reader 106. In an example embodiment, the navigation system 112 may utilize the GPS information and associate it with one or more of the RFID information or the one or more ROI images.

According to an example embodiment, the first vehicle 102 may include a remote communication unit (RMU) 114 that may communicate with a number of possible entities via a wireless network 116. For example, the wireless network 116 may be in communication with a remote database and/or other services. In one example embodiment, the RMU 114 and wireless network 116 may be utilized for communicating with a law enforcement entity. According to one example, the owner of the first vehicle 102 may opt-in to a crime reduction program that allows equipped vehicles to monitor other vehicles or events. In an example embodiment, the first vehicle 102 may be behind a second vehicle 104, and the front-facing camera attached to the first vehicle 102 may read a license plate of the second vehicle 104. According to an example embodiment, this license plate information may be communicated with GPS information to the law enforcement entity via the RMU 114 and wireless network 116. In this example embodiment, citizens may utilize embodiments of the invention to help provide extra surveillance on the road that may help apprehend criminals and reduce or prevent crime. According to an example embodiment, law enforcement may be seeking the whereabouts of a particular vehicle having a specific license plate number or other identifying characteristics. Example embodiments may provide distributed surveillance via the camera, RFID reader, RMU 114, and wireless communication for automatically identifying, locating, and communicating the location of a particular vehicle to law enforcement entities.

According to another example embodiment, the owner of the first vehicle 102 may be involved in a commercial program, for example, that provides some type of revenue or credits to the owner for gathering information with his or her vehicle. For example, a commercial entity may provide certain rewards to people who place an advertisement bumper sticker on their vehicles. According to an example embodiment, the commercial entity may base the rewards on the number of other vehicles that come in contact close enough to sense the information on the advertisement. In an example embodiment, the advertisement may be a bumper sticker with a certain image and/or an embedded RFID, tag that may be read by other vehicles. According to an example embodiment, when information associated with the bumper sticker is read by another vehicle, an indication may be communicated to the commercial entity via a RMU 114 and a wireless network 116, for example, to keep track of a “per-view” reward for attaching a bumper sticker to a vehicle.

According to another example embodiment, the RMU 114 may communicate, via the wireless network, owner notification information. For example, owner notification, may include the time and/or location of the first vehicle 102 when certain information was read from an information object 108 attached to the second vehicle 104.

According to an example embodiment, a query may be sent to one or more information sources based at least in part on the information read from an information object 108. According to an example embodiment, the information sources can include one or more of a cell phone, a local database device, a website, a remote server, or a remote database. According to an example embodiment, the query may include at least a portion of RFID information or information related to the one or more ROI images. According to an example embodiment, additional information may be returned to the querying the vehicle based at least in part on the query information sent to the one or more information sources.

According to an example embodiment, the RMU 114 may be utilized for associating data with information objects attached to the first vehicle 102. For example, the first vehicle 102 may have bumper stickers attached, and affiliation information, identification information, or personalized information may be associated with such bumper stickers via the RMU 114 and the wireless network 116. In this example, others reading the bumper sticker with their readers may view the information according to the settings provided by the owner of the first vehicle 102 and communicated to a common service or database via the wireless network 116.

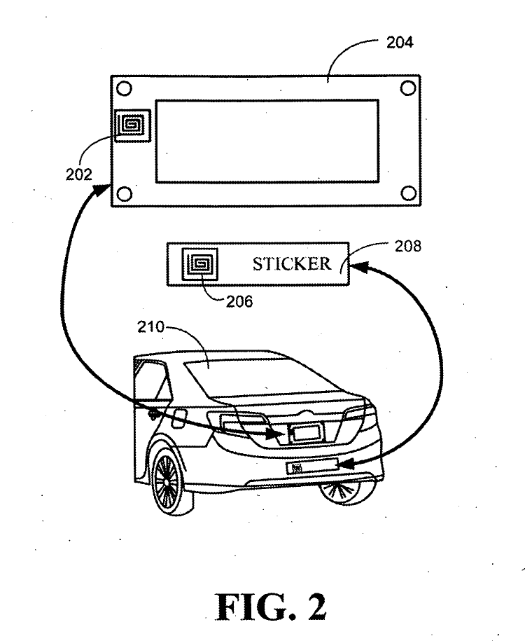

FIG. 2 is an illustrative example of information objects 202, 204, 206, 208 that may be attached to a vehicle 210, according to an example embodiment of the invention. In accordance with example embodiments, a RFID tag 202, 206 may be placed on or embedded in a license plate holder 204 or a bumper sticker 208 for attaching to a vehicle 210. According to an example embodiment, the RFID tag 202 may include data such as affiliation information, identification information, or personalized information. According, to example embodiments, the license plate holder 204 and/or the bumper sticker 208 may include graphics, text, images, or other visual information that may be read by a camera.

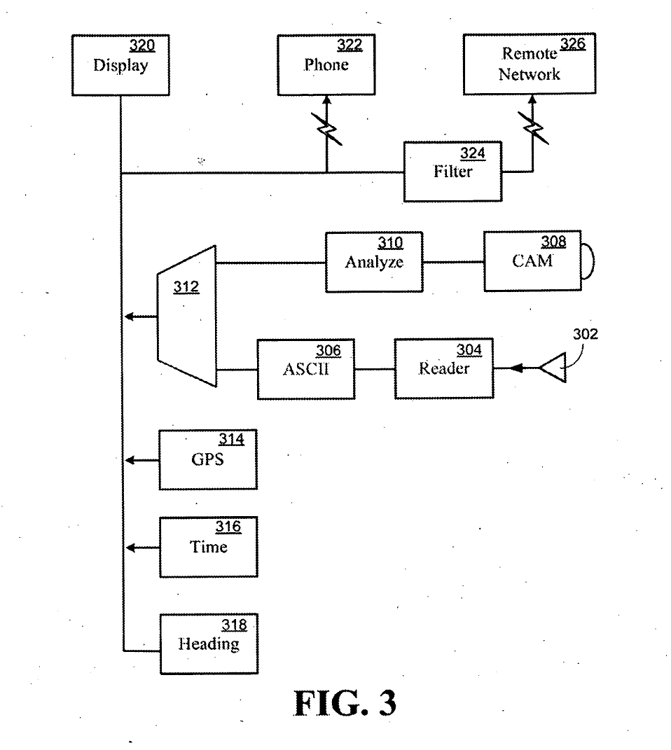

FIG. 3 is a block diagram depicting information capturing and processing elements, according to an example embodiment of the invention. According to an example embodiment, RFID data 302 may be read by a RFID reader 304 and data 306 (for example, ASCII code) may be extracted or interpreted from the RFID data 302. According to an example embodiment, the data 306 may be further processed 312 for presentation on a display 320 within the vehicle, sent to a phone 322, and/or further filtered 324 and sent to a remote network 326.

According to an example embodiment, a similar process may be carried out for image data that is captured by a camera 308. According to an example embodiment, the image data may be analyzed 310 and/or processed 312 for presentation on the display 320 within the vehicle, sent to a phone 322, and/or further filtered 324 and sent to a remote network 326. According to an example embodiment, the analyzing 310 and/or processing 312 may include determining a ROI associated with the captured images, determining focus, adjusting focus, determining a stability, enhancing stability, performing optical character recognition, determining a shape, performing shape recognition, determining one or more colors, adjusting sharpness, adjusting contrast, or adjusting brightness.

According to an example embodiment, additional information including GPS 314, time 316, and/or heading 318 information may also be provided for presentation on the display 320 within the vehicle, sent to a phone 322, and/or further filtered 324 and sent to a remote network 326.

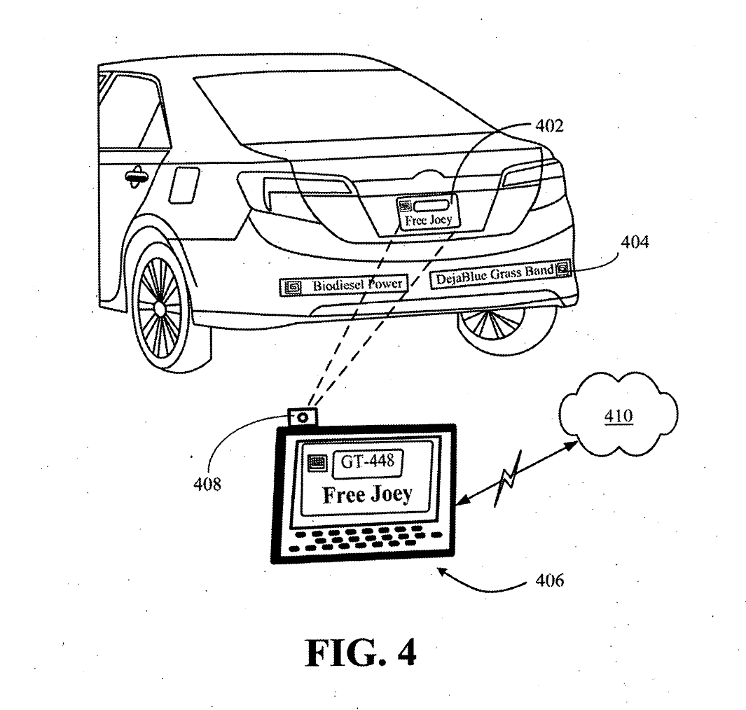

FIG. 4 is a diagram of an illustrative portable reader 406, according to an example embodiment of the invention. According to an example embodiment, the portable reader 406 may include a camera 408 for capturing images, for example, of a license plate 402 or bumper sticker 404 associated with a vehicle. In an example embodiment, the portable reader 406 may also include a RFID reader for reading RFID tags attached to the vehicle. According to an example embodiment, the portable reader 406 may communicate image and/or RFID information wirelessly with a remote network 410, which may, in turn, be in communication with a database or additional services. According to example embodiments, a similar process, as discussed with reference to FIGS. 1-3 may be carried out via the portable reader 406. In this example embodiment, the portable reader 406 may take on a number of embodiments, including a cell phone, a portable computer, a tablet computer, etc. According to an example embodiment, such a portable reader 406 may be utilized, for example, by parking enforcement to determine if a vehicle is authorized for parking in a particular location. According to an example embodiment, GPS data may be read by the portable reader 406 and incorporated into RFID and image data that may be sent to the network 410.

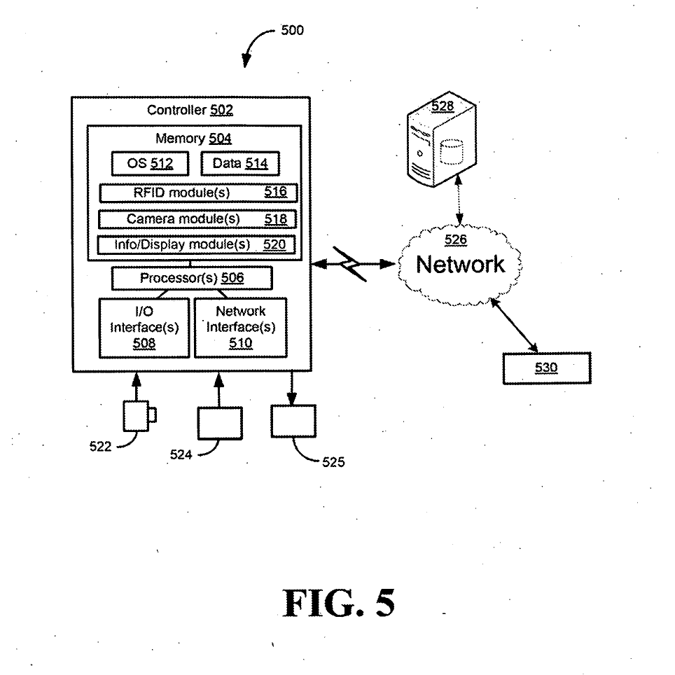

FIG. 5 depicts a block diagram of an illustrative system 500, according to an It) example embodiment of the invention. According to an example embodiment, the system 500 may include a controller 502 for receiving and processing information, including images and data from a camera 522 and a RFID reader 524. According to an example embodiment, the processed information may be communicated to one or more wireless networks 526, which may be in communication with a remote server/database 528, and/or services 530 including law enforcement, commerce, notification, credits, or services for communicating with other vehicles.

According to an example embodiment, the controller 502 may include a memory 504 in communication with one or more processors 506. The memory may include an operating system 512 and data 514. According to an example embodiment, the memory 504 may include various computer readable code modules 516, 518, 520 for processing information from the camera 522 and/or the RFID reader 524. For example, the, memory 504 may include a RFID module 516 for processing RFID tag data by the RFID reader. In an example embodiment, the RFID module 516 may extract and format digital data read via the RFID reader. According to an example embodiment, the memory 504 may include camera module 518 for processing image information captured by the camera 522. In an example embodiment, the camera module may work in conjunction with the one or more processors 506 to perform one or more of determining focus, adjusting focus, determining a stability, enhancing stability, performing optical character recognition, determining a shape, performing shape recognition, determining one or more colors, adjusting sharpness, adjusting contrast, or adjusting brightness associated with the camera images. According to an example embodiment, the memory may include an information display module 520 for filtering, adjusting, scaling, or formatting data associated with the images or RFID information presented on one or more displays 525.

In an example embodiment, one or more input/output interfaces 508 may be utilized to interface the camera 522 and RFID reader 524 with the one or more processors 506. According to an example embodiment, one or more network interfaces 510 may be utilized for communicating processed data to the network 526. For example, the one or more network interfaces 510 may include cellular, Wi-Fi, or other wireless components for communicating with remote devices or services via the network 526.

According to an example embodiment, the memory may include other modules for processing data. For example, a module may be utilized in conjunction with the one or more processors 506 for determining one or more of permission or security information associated with outputting information or commands, or communicating via the network 526.

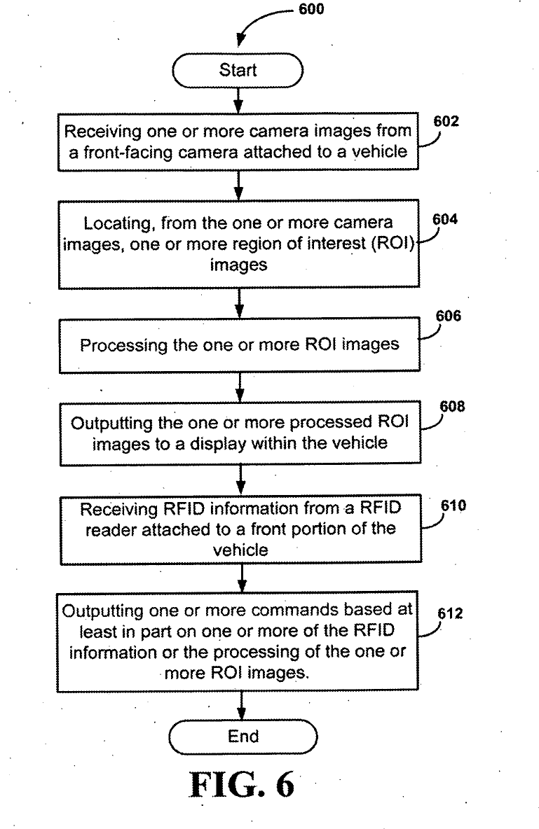

An example method 600 will now be described with reference to the flow diagram of FIG. 6. The method 600 starts in block 602, and according to an example embodiment of the invention includes receiving one or more camera images from a front-facing camera attached to a vehicle. In block 604, the method 600 includes locating, from the one or more camera images, one or more region of interest (ROI) images. In block 606, the method 600 includes processing the one or more ROI images. In block 608, the method 600 includes outputting the one or more processed ROI images to a display within the vehicle. In block 610, the method 600 includes receiving RFID information from a RFID reader attached to a front portion of the vehicle. In block 612, the method 600 includes outputting one or more commands based at least in part on one or more of the RFID information or the processing of the one or more ROI images. The method 600 ends after block 612.

According to example embodiments, certain technical effects can be provided, such as creating certain systems, methods, and apparatus that provide enhanced clarity, readability, and/or additional information associated with a bumper sticker or other information item attached to a vehicle. Example embodiments of the invention can provide the further technical effects of providing systems, methods, and apparatus for locating regions of interest in captured images associated with a vehicle and dynamically tracking such regions of interest for display.

In example embodiments of the invention, the system 500 may include any number of hardware and/or software applications that are executed to facilitate any of the operations. In example embodiments, one or more input/output interfaces may facilitate communication between the system 500 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the system 500. The one or more input/output interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the system 500 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network, any wired network, any wireless network, etc., for communication with external devices and/or systems.

As desired, embodiments of the invention may include the system 500 with more or less of the components illustrated in FIG. 5.

Certain embodiments of the invention are described above with reference to block and flow diagrams of systems, methods, apparatus, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method comprising executing computer executable-instructions by one or more processors, the method further comprising:
receiving one or more camera images from a front-facing camera attached to a vehicle;
locating, from the one or more camera images, one or more region of interest (ROI) images;
processing the one or more ROI images;
outputting the one or more processed ROI images to a display within the vehicle;
receiving RFID information from a RFID reader attached to a front portion of the vehicle; and
outputting one or more commands based at least in part on one or more of the RFID information or the processing of the one or more ROI images.

2. The method of claim 1, wherein the locating of the one or more regions of interest comprises locating, in a field of view of the camera, one or more items attached to a separate vehicle, wherein the one or more items comprise one or more of a bumper sticker, a decal, make or model indicia, a license plate, a license plate holder, an external display or a tag.

3. The method of claim 1, wherein processing the one or more ROI images comprises one or more of determining focus, adjusting focus, determining a stability, enhancing stability, performing optical character recognition, determining a shape, performing shape recognition, determining one or more colors, adjusting sharpness, adjusting contrast, or adjusting brightness.

4. The method of claim 1, further comprising receiving global positioning system (GPS) information associated with one or more of the RFID information or the one or more ROI images, and outputting one or more commands based at least in part on the GPS information.

5. The method of claim 1, wherein outputting the one or more commands comprises sending a query to one or more information sources comprising one or more of a local device, a website, a remote server, or a remote database, wherein the query comprises at least a portion of RFID information or information related to the one or more ROI images.

6. The method of claim 5, further comprising:
receiving, from the one or more information sources, additional information associated with the RFID information or the one or more ROI images;
processing the additional information; and
outputting the processed additional information on the display within the vehicle.

7. The method of claim 6, wherein the additional information comprises one or more of affiliation information, identification information, or personalized information.

8. The method of claim 1, further comprising determining one or more of permission or security information associated with outputting the one or more commands.

9. A vehicle comprising:
a camera attached to the vehicle and positioned with a field of view in front of the vehicle;
a display device attached to the vehicle;
a radio frequency identification (RFID) reader attached to a front portion of the vehicle;
at least one memory for storing data and computer-executable instructions; and
one or more processors configured to access the at least one memory and further configured to execute computer-executable instructions for:
receiving one or more camera images from the camera;
locating, from the one or more camera images, one or more region of interest (ROI) images;
processing the one or more ROI images;
outputting the one or more processed ROI images to the display device;
receiving RFID information from the RFID reader; and
outputting one or more commands based at least in part on one or more of the RFID information or the processing of the one or more ROI images.

10. The vehicle of claim 9, wherein locating the one or more regions of interest comprises locating, in a field of view of the camera, one or more items attached to a separate vehicle, wherein the one or more items comprise one or more of a bumper sticker, a decal, make or model indicia, a license plate, a license plate holder, an external display, or a tag.

11. The vehicle of claim 9, wherein processing the one or more ROI images comprises one or more of determining camera focus, adjusting camera focus, determining image stability, enhancing image stability, performing optical character recognition, determining a shape, performing shape recognition, determining one or more colors, adjusting sharpness, adjusting contrast, or adjusting brightness.

12. The vehicle of claim 9, further comprising a global positioning system (GPS) device, and wherein the one or more processors are further configured to receive GPS information to associate with one or more of the RFID information or the one or more ROI images, and outputting one or more commands based at least in part on the GPS information.

13. The vehicle of claim 9, wherein outputting the one or more commands comprises sending a query to one or more information sources comprising one or more of a cell phone, a local database device, a website, a remote server, or a remote database, wherein the query comprises at least a portion of RFID information or information related to the one or more ROI images.

14. The vehicle of claim 9, wherein the one or more processors are further configured for:
receiving, from the one or more information sources, additional information associated with the RFID information or the one or more ROI images:
processing the additional information; and
outputting the processed additional information to the display device.

15. The vehicle of claim 14, wherein the additional information comprises one or more of affiliation information, identification information, or personalized information.

16. The vehicle of claim 9, wherein the one or more processors are further configured for determining one or more of permission or security information associated with outputting the one or more commands.

17. An apparatus comprising:
at least one memory for storing data and computer-executable instructions; and
one or more processors configured to access the at least one memory and further configured to execute computer-executable instructions for:
receiving one or more camera images from a front-facing camera attached to a vehicle;
locating, from the one or more camera images, one or more region of interest (ROI) images;
processing the one or more ROI images;
outputting the one or more processed ROI images to a display attached to the vehicle;
receiving RFID information from a RFID reader attached to the vehicle; and
outputting one or more commands based at least in part on one or more of the RFID information or the processing of the one or more ROI images.

18. The apparatus of claim 17, wherein locating the one or more regions of interest comprises locating, in a field of view of the camera, one or more items attached to a separate vehicle, wherein the one or more items comprise one or more of a bumper sticker, a decal, make or model indicia, a license plate, a license plate holder, an external display, or a tag.

19. The apparatus of claim 17, wherein processing the one or more ROI images comprises one or more of determining camera focus, adjusting camera focus, determining image stability, enhancing image stability, performing optical character recognition, determining a shape, performing shape recognition, determining one or more colors, adjusting sharpness, adjusting contrast, or adjusting brightness.

20. The apparatus of claim 17, wherein the one or more processors are further configured to receive GPS information to associate with one or more of the RFID information or the one or more ROI images and outputting one or more commands based at least in part on the GPS information.

21. The apparatus of claim 17, wherein outputting the one or more commands comprises sending a query to one or more information sources comprising one or more of a cell phone, a local database device, a website, a remote server, or a remote database, wherein the query comprises at least a portion of RFID information or information related to the one or more ROI images.

22. The apparatus of claim 21, wherein the one or more processors are further configured for:
receiving, from the one or more information sources, additional information associated with the RFID information or the one or more ROI images:
processing the additional information; and
outputting the processed additional information to the display.

23. The apparatus of claim 22, wherein the additional information comprises one or more of affiliation information, identification information, or personalized information.

24. The apparatus of claim 17, wherein the one or more processors are further configured for determining one or more of permission or security information associated with outputting the one or more commands.

25. A computer program product, comprising a computer-usable medium having a computer-readable program code embodied therein, said computer-readable program code adapted to be executed to implement a method for reading and processing image and radio frequency identification (RFID) information, the method further comprising:
receiving one or more camera images from a front-facing camera attached to a vehicle;
locating, from the one or more camera images, one or more region of interest (ROI) images;
processing the one or more ROI images;
outputting the one or more processed ROI images to a display within the vehicle:
receiving RFID information from a RFID reader attached to a front portion of the vehicle;
determining one or more of permission information or security information; and
outputting one or More commands based at least in part on one or more of the permission information, the security information, the RFID information, or the processing of the one or more ROI images.

26. The computer program product of claim 25, wherein locating the one or more regions of interest comprises locating, in a field of view of the camera, one or more items attached to a separate vehicle, wherein the one or more items comprise one or more of a bumper sticker, a decal, make or model indicia, a license plate, a license plate holder, an external display, or a tag.

27. The computer program product of claim 25, wherein processing the one or more ROI images comprises one or more of determining focus, adjusting focus, determining a stability, enhancing stability, performing optical character recognition, determining a shape, performing shape recognition, determining one or more colors, adjusting sharpness, adjusting contrast, or adjusting brightness.

28. The computer program product of claim 25, further comprising receiving global positioning system (GPS) information for associating with one or more of the RFID information or the one or more ROI images and outputting one or more commands based at least in part on the GPS information.

29. The computer program product of claim 25, wherein outputting the one or more commands comprises sending a query to one or more information sources comprising one or more of a local device, a website, a remote server, or'a remote database, wherein the query comprises at least a portion of RFID information or information related to the one or more ROI images.

30. The computer program product of claim 29, further comprising:
receiving, from one or more information sources, additional information associated with the RFID information or one or more ROI images, wherein the additional information comprises one or more of affiliation information, identification information, or personalized information;
processing the additional information; and
outputting the processed additional information on the display within the vehicle.
